(19) United States
(12) Patent Application Publication
(10) Pub. No.: US 2016/0335835 A1
(43) Pub. Date: Nov. 17, 2016

(54) GAMING SYSTEMS AND ELECTRONIC GAMING MACHINES WITH MULTI-DISPLAY DEVICE ARRANGEMENTS

(71) Applicant: WMS Gaming Inc., Waukegan, IL (US)

(72) Inventors: Christian L. Castro, Chicago, IL (US); Robert J. Glenn, Chicago, IL (US); Paul M. Lesley, Blue Island, IL (US)

(21) Appl. No.: 14/713,023

(22) Filed: May 15, 2015

(51) Int. Cl. G07F 17/32; G07F 17/34

(52) U.S. Cl. CPC G07F 17/322; G07F 17/34; G07F 17/3211

(57) ABSTRACT

Presented herein are gaming systems, electronic gaming machines, and multi-display arrangements for wagering game terminals. An electronic gaming machine is disclosed which includes a gaming cabinet with first and second electronic display devices coupled to the cabinet in side-by-side non-coplanar relationship. The first display device includes a first glass panel overlaying a first video display panel, whereas the second display device includes a second glass panel overlaying a second video display panel. Each video display panel is configured to display aspects of a casino wagering game. An elongated transition spacer is seated inside and extends across a gap between the first and second glass panels. The transition spacer has first and second pockets on opposing sides thereof. Each of the pockets seats therein and couples to an edge of a respective one of the glass panels.

### COPYRIGHT

A portion of the disclosure of this patent document contains materials which are subject to copyright protection. The copyright owner has no objection to the facsimile reproduction by anyone of the patent disclosure, as it appears in the Patent and Trademark Office patent files or records, but otherwise reserves all copyright rights whatsoever.

### TECHNICAL FIELD

The present disclosure relates generally to electronic wagering game machines, casino gaming systems, gaming networks, and methods for assembling casino gaming terminals. More particularly, aspects of the present disclosure relate to electronic gaming machines (EGM) with multi-display device arrangements.

### BACKGROUND

Electronic gaming machines (EGM), such as slot machines, video poker machines, and the like, have become a cornerstone of the gaming industry. Generally, the popularity of such machines with players is dependent on the likelihood (or perceived likelihood) of winning money at the machine and the entertainment value of the machine relative to other available gaming options. Where the available gaming options include a number of competing machines, and the expectation of winning at each machine is roughly the same (or believed to be the same), players are typically attracted to the most engaging, entertaining and exciting machines. Shrewd operators consequently strive to employ technologically advanced gaming devices that can provide the most engaging, entertaining and exciting game features and enhancements because such devices attract frequent play and, hence, increase profitability to the operator. Thus, gaming manufacturers continuously endeavor to develop advanced gaming machines with improved gaming enhancements that will attract frequent play and player loyalty through enhanced entertainment value to the player.

One way to improve the gaming experience and increase the entertainment value of a particular wagering game is to enhance the display features of the electronic gaming machine associated with that wagering game. Most gaming machines include a variety of visual attractions and displays, such as models, signs, and other forms of information. These items typically include fixed permanently-printed glass, video display devices, artwork, models, and marquees. In many gaming regions, industry regulations in fact require every gaming terminal include top-box mounted lighting and signage that indicate, for example, the class of machine, when the machine is out of funds, when the machine is malfunctioning, etc. For gaming machines with electronic video display devices, improvements in hi-definition video technology, such as liquid crystal display (LCD) panels, plasma display panels, and light emitting diode (LED) displays, have enabled the presentation of richer and more colorful graphics.

Historically, an electronic gaming machine is limited to a primary display device and, for many models, a dedicated top box display arrangement that may include a top-box mounted marquee assembly, video display device, or permanently-printed signage. For most conventional multi-display configurations, the gaming terminal's primary and top-box mounted display devices are rigidly mounted to the cabinet, juxtaposed one on top of the other in a generally parallel, often coplanar layout. The external trim structure of the gaming terminal's cabinet between individual video display devices is often large segments of unused “dead” space. New developments in graphical display arrangements, including those that eliminate or better use said “dead” space in multi-display arrangements, creating more seamless display surfaces, can further enhance player appeal and, thus, increase game play and player loyalty.

### SUMMARY

Aspects of the present disclosure are directed to electronic gaming machines (EGM), casino gaming systems and networks, multi-display arrangements for wagering game terminals, and methods of assembling such multi-display arrangements. Disclosed, for example, is a multi-display arrangement for a floor-standing wagering game terminal. Depending on the desired configuration, two or three or more video display panels are mounted adjacent one another, spaced vertically or horizontally with respect to the cabinet of the gaming terminal. Each video display panel is oriented at an oblique angle with respect to any neighboring display panels. For instance, a central display panel (e.g., a 26.5″ 1920X1920 QHD LCD panel) is centrally mounted on the cabinet above the cabinet's player input (button-panel) deck. This central display panel is flanked on its lateral sides by left-hand-side and right-hand-side display panels (e.g., two 21.5″ 1920X1080 HD LCD panels), each of which is obliquely angled, e.g., approximately 145 degrees, with respect to the central display panel. Alternative configurations may comprise multiple identical display panels (e.g., three 27″ 1920X1080 HD LCD panels) juxtaposed in side-by-side non-coplanar relationship.

To provide a visually seamless transition between adjacent display panels, as well as to ensure proper alignment, provide a more secure attachment and reduce moisture ingress, a custom-made spacer is mounted between the glass panels of neighboring display devices. According to one exemplary configuration, the spacer has a T-shaped cross section with a vertically oriented stem and a laterally oriented arm (sometimes referred to as “crossbar”) at one end of the stem. Optional flanges (or “serifs”) are located at the lateral ends of the arm and/or at an opposing end of the stem. The arm and stem create a first (left-hand) pocket and a second (right-hand) pocket, where each pocket is configured to receive therein and attach to a lateral edge of one of the glass panels. The lateral edge of the glass can be beveled or rounded to improve attachment with the spacer. For some configurations, the stem of the spacer has a varying thickness along the length thereof. In at least some configurations, the arm is rounded or has a rounded (convex) upper surface. Similarly, for some configurations, the serif on the opposing end of the stem is rounded or has a rounded (concave) bottom surface.

Aspects of the present disclosure are directed to electronic gaming machines (EGM), such as floor-standing casino slot machines, for conducting wagering games. For example, disclosed herein is an EGM that is primarily dedicated to conducting at least one regulated casino wagering game. The EGM includes a gaming cabinet for housing electronic components, and first and second electronic display devices coupled to the gaming cabinet in side-by-side non-coplanar relationship. The first electronic display device includes a first glass panel overlaying a first video display panel. Likewise, the second electronic display device includes a second glass panel overlaying a second video display panel. Each of the video display panels is configured to display aspects of the casino wagering game. An elongated transition spacer is seated at least partially inside and extends across a gap between the first and second glass panels. The transition spacer defines first and second pockets on opposing sides thereof. Each of the pockets seats therein an edge of a respective one of the first and second glass panels. The elongated transition spacer may extend the entire length or substantially the entire length of the edges of the glass panels. The visually perceptible portion of the spacer, namely the surface seen by the player, is less than 3 mm wide in at least some embodiments. The first and/or the second display glass panels could include a laminated touchscreen, such as a surface capacitive or a projected capacitve film or glass for converting the display into an interactive touch screen

Other aspects of the present disclosure are directed to gaming systems for conducting wagering games. For example, disclosed is a casino gaming system that is primarily dedicated to conducting at least one regulated casino wagering game. The gaming system includes a gaming cabinet configured to house electronic components, and an electronic input device mounted on the cabinet. The input device is configured to receive a physical input from a player to initiate a wagering game, and transform the physical input into an electronic data signal. The gaming system also includes game-logic circuitry with a random element generator that is configured to generate, in response to the electronic data signal from the electronic input device, one or more random elements associated with play of the wagering game. First and second electronic display devices, which may be in the nature of flat panel displays, are mounted on the cabinet in side-by-side non-coplanar relationship. The first display device includes a first video display panel covered with a first glass panel, whereas the second display device includes a second video display panel covered with a second glass panel. Each video display panel is configured to display aspects of the wagering game. An elongated transition spacer is seated at least partially inside and extends across a gap between the first and second glass panels. The transition spacer has first and second pockets on opposing sides thereof. Each of these pockets seats therein and couples to an edge of a respective one of the glass panels, e.g., via an interference fit.

Additional aspects of this disclosure are directed to display arrangements for electronic gaming machines. In an example, disclosed herein is a multi-display arrangement for an electronic wagering game terminal. The multi-display arrangement includes a first electronic display device that is configured to mount to the gaming cabinet in a first position. The first electronic display device has a first glass panel overlaying a first video display panel. The first video display panel is configured to dynamically display aspects of a casino wagering game. A second electronic display device is configured to mount to the cabinet in a second position adjacent to and at an oblique angle with the first electronic display device. The second electronic display device has a second glass panel overlaying a second video display panel. The second video display panel is also configured to dynamically display aspects of the casino wagering game. An elongated transition spacer is seated substantially inside and extends across a gap between the first and second glass panels. This transition spacer defines first and second pockets on opposing sides thereof. Each of the pockets seats therein an edge of a respective one of the glass panels.

The above summary does not represent every embodiment or every aspect of the present disclosure. Rather, the foregoing summary merely provides an exemplification of some of the novel aspects and features set forth herein. The above features and advantages, and other features and advantages of the present disclosure, which are considered to be inventive singly or in any combination, will be readily apparent from the following detailed description of representative embodiments and modes for carrying out the present invention when taken in connection with the accompanying drawings and the appended claims.

### BRIEF DESCRIPTION OF THE DRAWINGS

FIG. 1 is a perspective-view illustration of a representative floor-standing electronic gaming machine (EGM) according to aspects of the present disclosure.

FIG. 2 is a schematic diagram of a representative electronic gaming machine (EGM) in a networked gaming system according to aspects of the present disclosure.

FIG. 3 is a screen shot of a representative basic-game screen of a casino game displayed on a dedicated casino gaming device according to aspects of the present disclosure.

FIG. 4 is a front-view illustration of a representative multi-display arrangement for a wagering game terminal in accordance with aspects of the present disclosure.

FIG. 5 is a plan-view cross-sectional illustration of a portion of the multi-display arrangement taken along line 5-5 of FIG. 4 showing a transition spacer disposed between the glass panels of neighboring display devices.

FIG. 6 is a perspective view illustration of the transition spacer of FIG. 5.

FIG. 7 a cross-sectional illustration of the transition spacer of FIG. 5 taken along line 7-7 of FIG. 6.

The present disclosure is susceptible to various modifications and alternative forms, and some representative embodiments have been shown by way of example in the drawings and will be described in detail herein. It should be understood, however, that the inventive aspects are not limited to the particular forms illustrated in the drawings. Rather, the disclosure is to cover all modifications, equivalents, and alternatives falling within the spirit and scope of the invention as defined by the appended claims.

### DETAILED DESCRIPTION OF ILLUSTRATED EXAMPLES

This disclosure is susceptible of embodiment in many different forms. There are shown in the drawings, and will herein be described in detail, representative embodiments with the understanding that the present disclosure is to be considered as an exemplification of the principles of the present disclosure and is not intended to limit the broad aspects of the disclosure to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference or otherwise. For purposes of the present detailed description, unless specifically disclaimed or logically prohibited: the singular includes the plural and vice versa; and the words “including” or “comprising” or “having” means “including without limitation.” Moreover, words of approximation, such as “about,” “almost,” “substantially,” “approximately,” and the like, can be used herein in the sense of “at, near, or nearly at,” or “within 3-5% of,” or “within acceptable manufacturing tolerances,” or any logical combination thereof, for example.”

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

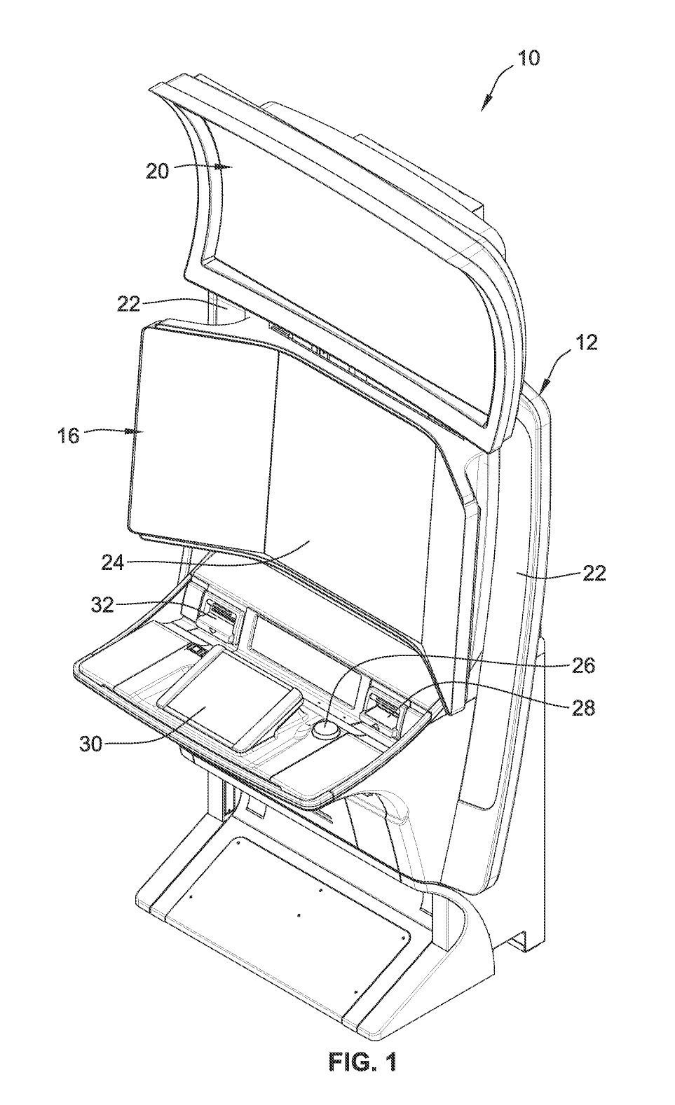

Referring to the drawings, wherein like reference numerals refer to like features throughout the several views, there is shown in FIG. 1 an electronic gaming machine (EGM), designated generally at 10, similar to those operated in gaming establishments, such as casinos. With regard to the present disclosure, the gaming machine 10 may be any type of gaming terminal or machine (“gaming terminal” and “gaming machine” and “gaming device” being used interchangeably in this disclosure) and may have varying structures and methods of operation. For example, in some aspects, the gaming machine 10 is an electromechanical gaming terminal configured to play slots with mechanical reels, whereas in other aspects, the gaming machine is an electronic gaming terminal configured to play a video casino game, such as slots, keno, poker, blackjack, roulette, craps, etc. The gaming machine 10 may take any suitable form, such as floor-standing models (as shown), handheld mobile gaming units, bartop gaming models, workstation-type console models, etc. Further, the gaming machine 10 may be primarily dedicated for use in playing casino wagering games, or may include non-dedicated devices, such as mobile phones, personal digital assistants, personal computers, etc. Exemplary types of gaming machines are disclosed in U.S. Pat. Nos. 6,517,433, 8,057,303, and 8,226,459, all of which are incorporated herein by reference in their respective entireties and for all purposes.

The gaming machine 10 illustrated in FIG. 1 comprises a gaming cabinet 12 that securely houses various input devices, output devices, input/output devices, internal electronic/electromechanical components, and wiring. The cabinet 12 includes exterior walls, interior walls and shelves for mounting the internal components and managing the wiring, and one or more front, side or rear doors that are locked and require a physical or electronic key to gain access to the interior compartment of the cabinet 12 behind the locked door. The cabinet 12 forms an alcove configured to store one or more beverages or personal items of a player. A notification mechanism, such as a candle or tower light, can be mounted to the top of the cabinet 12. It flashes to alert an attendant that change is needed, a hand pay is requested, or there is a potential problem with the gaming machine 10.

The input devices, output devices, and input/output devices are disposed on, and securely coupled to, the cabinet 12. By way of example, the output devices include a primary display area 18, a secondary display area 20, and one or more audio speakers 22. The primary display area 18 may comprise a mechanical-reel display device, one or more video display devices, or a combination thereof. Some configurations comprise a transmissive video display that is disposed in front of the electro-mechanical reels to portray a video image superimposed upon the mechanical-reel display. The displays variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. As input devices, the gaming machine 10 includes a touch screen(s) 24 mounted, for example, over one or more screens of the primary display area 18, and one or more push buttons 26 and one or more soft buttons 30 mounted on a player input deck. Also included are a bill/ticket acceptor and card reader/writer 28, a ticket dispenser 32, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen 24, buttons 26, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

The gaming machine 10 includes one or more value input/payment devices and value output/payout devices. The value input devices are used to deposit cash or credits onto the gaming machine 10. The cash or credits are used to fund wagers placed on the wagering game played via the gaming machine 10. Examples of value input devices include, but are not limited to, a coin acceptor, the bill/ticket acceptor and card reader/writer 28, a wireless communication interface for reading cash or credit data from a nearby mobile device, and a network interface for withdrawing cash or credits from a remote account via an electronic funds transfer. The value output devices are used to dispense cash or credits from the gaming machine 10. The credits may be exchanged for cash at, for example, a cashier or redemption station. Examples of value output devices include, but are not limited to, a coin hopper for dispensing coins or tokens, a bill dispenser, the card reader/writer, the ticket dispenser for printing tickets redeemable for cash or credits, a wireless communication interface for transmitting cash or credit data to a nearby mobile device, and a network interface for depositing cash or credits to a remote account via an electronic funds transfer.

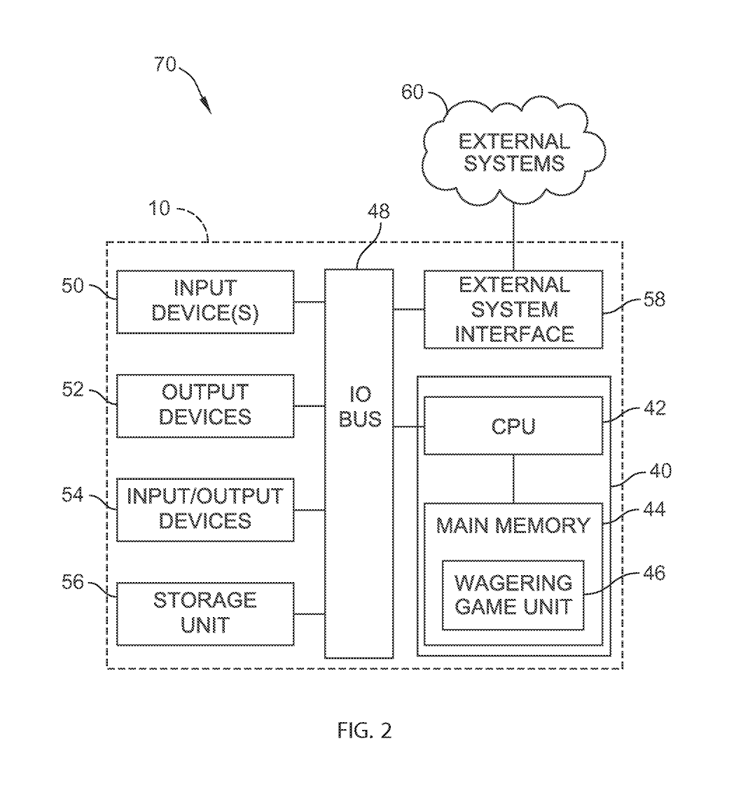

Turning now to FIG. 2, there is shown a block diagram of the gaming-machine architecture. The gaming machine 10 includes game-logic circuitry 40 securely housed within a locked box inside the gaming cabinet 12 (see FIG. 1). The game-logic circuitry 40 includes a central processing unit (CPU) 42 connected to a main memory 44 that comprises one or more memory devices. The CPU 42 includes any suitable processor(s), such as those made by Intel and AMD. By way of example, the CPU 42 includes a plurality of microprocessors including a master processor, a slave processor, and a secondary or parallel processor. Game-logic circuitry 40, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 40, and more specifically the CPU 42, comprises one or more controllers or processors and such one or more controllers or processors need not be disposed proximal to one another and may be located in different devices or in different locations. The game-logic circuitry 40, and more specifically the main memory 44, comprises one or more memory devices which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video black jack, video slots, video lottery, etc., in whole or part.

The game-logic circuitry 40 is also connected to an input/output (I/O) bus 48, which can include any suitable bus technologies, such as an AGTL+ frontside bus and a PCI backside bus. The I/O bus 48 is connected to various input devices 50, output devices 52, and input/output devices 54 such as those discussed above in connection with FIG. 1. The I/O bus 48 is also connected to a storage unit 56 and an external-system interface 58, which is connected to external system(s) 60 (e.g., wagering-game networks). In the example shown in FIG. 2, the EGM 10 is part of a networked gaming system 70.

The external system 60 includes, in various aspects, a gaming network, other gaming machines or terminals, a gaming server, a remote controller, communications hardware, or a variety of other interfaced systems or components, in any combination. In yet other aspects, the external system 60 comprises a player's portable electronic device (e.g., cellular phone, electronic wallet, etc.) and the external-system interface 58 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 60 such that the gaming machine 10 operates as a thin, thick, or intermediate client. The game-logic circuitry 40—whether located within (“thick client”), external to (“thin client”), or distributed both within and external to (“intermediate client”) the gaming machine 10—is utilized to provide a wagering game on the gaming machine 10. In general, the main memory 44 stores programming for a random number generator (RNG), game-outcome logic, and game assets (e.g., art, sound, etc.)—all of which obtained regulatory approval from a gaming control board or commission and are verified by a trusted authentication program in the main memory 44 prior to game execution. The authentication program generates a live authentication code (e.g., digital signature or hash) from the memory contents and compare it to a trusted code stored in the main memory 44. If the codes match, authentication is deemed a success and the game is permitted to execute. If, however, the codes do not match, authentication is deemed a failure that must be corrected prior to game execution. Without this predictable and repeatable authentication, the gaming machine 10, external system 60, or both, are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 10 by accessing the associated game assets, required for the resultant outcome, from the main memory 44. The CPU 42 causes the game assets to be presented to the player as outputs from the gaming machine 10 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player, for example, at a minimum of 100 Hz (100 calls per second) as set forth in Nevada's New Gaming Device Submission Package. Accordingly, the RNG cannot be carried out manually by a human and is integral to operating the game.

The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 10 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

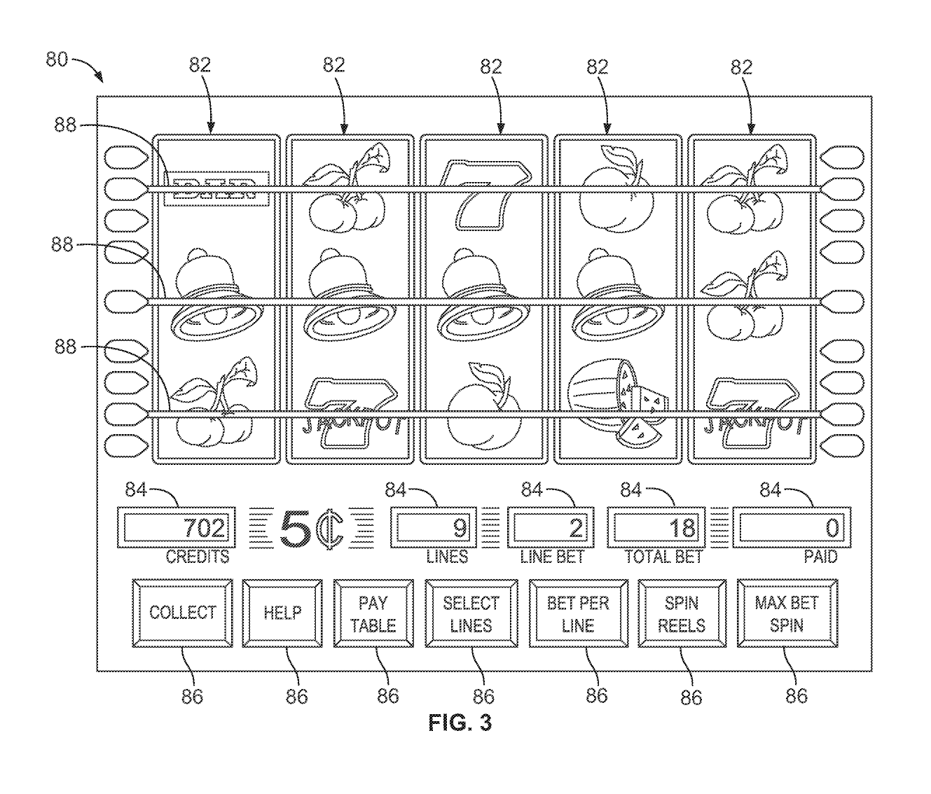

Referring now to FIG. 3, there is illustrated an image of a basic-game screen 80 adapted to be displayed on the primary display 18 or the secondary display 20. The basic-game screen 80 portrays a plurality of simulated symbol-bearing reels 82. Alternatively or additionally, the basic-game screen 80 portrays a plurality of mechanical reels or other video or mechanical presentation consistent with the game format and theme. The basic-game screen 80 also advantageously displays one or more game-session credit meters 84 and various touch screen buttons 86 adapted to be actuated by a player. A player can operate or interact with the wagering game using these touch screen buttons or other input devices such as the buttons 26 shown in FIG. 1. The game-logic circuitry 40 operates to execute a wagering-game program causing the primary display 18 or the secondary display 20 to display the wagering game.

In response to receiving an input indicative of a wager, the reels 82 are rotated and stopped to place symbols on the reels in visual association with paylines such as paylines 88. The wagering game evaluates the displayed array of symbols on the stopped reels and provides immediate awards and bonus features in accordance with a pay table. The pay table may, for example, include “line pays” or “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus features based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array.

In accord with various methods of conducting a wagering game on a gaming system in accord with the present concepts, the wagering game includes a game sequence in which a player makes a wager and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary display 18 or secondary display 20) through the display of information such as, but not limited to, text, graphics, static images, moving images, etc., or any combination thereof. In accord with the method of conducting the wagering game, the game-logic circuitry 40 transforms a physical player input, such as a player's pressing of a “Spin Reels” touch key, into an electronic data signal indicative of an instruction relating to the wagering game (e.g., an electronic data signal bearing data on a wager amount).

In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 42 (e.g., the wager in the present example). As another example, the CPU 42 further, in accord with the execution of the stored instructions relating to the wagering game, causes the primary display 18, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter.

In one embodiment, the gaming machine 10 and, additionally or alternatively, the external system 60 (e.g., a gaming server), means gaming equipment that meets the hardware and software requirements for fairness, security, and predictability as established by at least one state's gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in other gaming jurisdictions. As can be seen from the description herein, the gaming machine 10 may be implemented with hardware and software architectures, circuitry, and other special features that differentiate it from general-purpose computers (e.g., desktop PCs, laptops, and tablets).

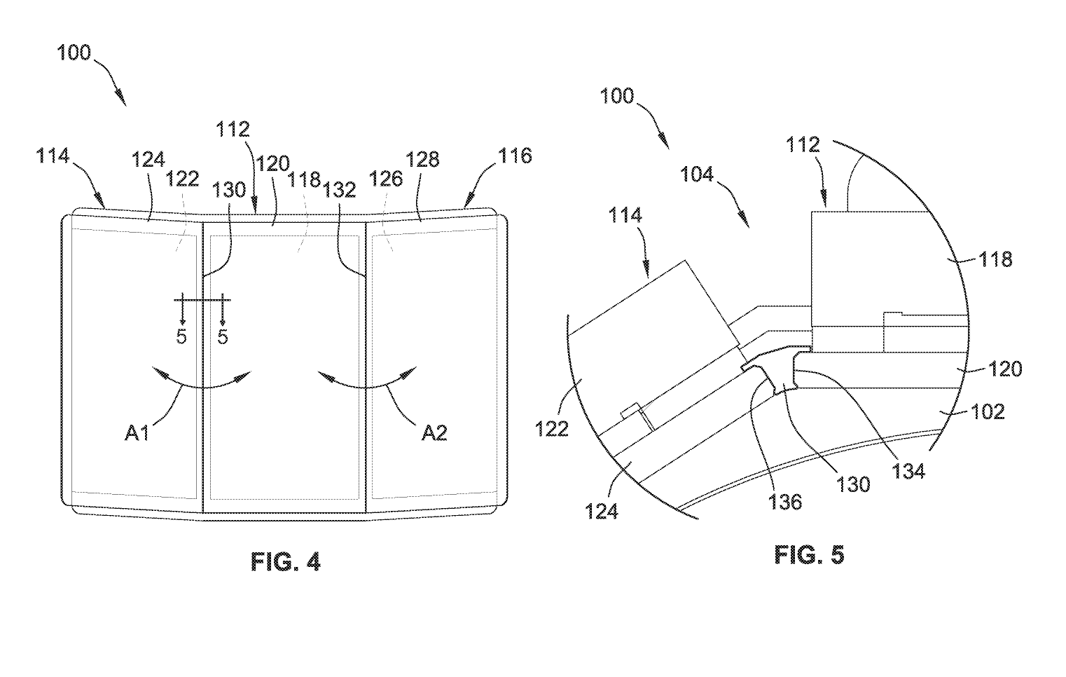

FIG. 4 is a front-view illustration of a representative multi-display arrangement, designated generally at 100, for a wagering game terminal, such as electronic gaming machine 10 of FIG. 1, or a gaming system, such as networked gaming system 70 of FIG. 2. Although differing slightly in appearance, the display arrangement 100 can be identical with or otherwise similar in function, operation, and connectivity to the primary display area 18 discussed above with respect to FIG. 1, and, thus, can include any of the corresponding features and options thereof. Display arrangement 100 may include, for example, one or more mechanical-reel displays, one or more electronic video displays, one or more transmissive displays, other known display devices, and combinations thereof. As shown, the display arrangement 100 includes three electronic display devices—a first (central) display device 112, a second (left-hand-side) display device 114, and a third (right-hand-side) display device 116—which are mounted adjacent one another and spaced either horizontally or vertically, e.g., with respect to a cabinet of a gaming terminal. Each of the display devices 112, 114, 116 may take on various forms of electronic displays, including, without limitation, a high-resolution liquid crystal display (LCD), a plasma display, a light emitting diode (LED), an electroluminescent (EL) panel, or any other type of display suitable for use in a gaming terminal. As shown, the central display device 112 is a 26.5″ Quad High Definition (QHD) liquid crystal display (LCD) flat panel display, while the left-hand and right-hand-side display devices 114, 116 are each 21.5″ High Definition (HD) LCD flat panel displays. In the illustrated example, a display housing 102 (FIG. 5) provides mounting structure for securing together the three display devices 112, 114, 116 and provides internal packaging space for stowing and securing at least some of the electronic hardware of the electronic display devices 112, 114, 116. A mounting assembly (not visible in the views provided) on the rear side of the housing 102 is configured to mount the multi-display arrangement 100 to the cabinet of a floor-standing gaming terminal or other comparable support structure.

Each display device 112, 114, 116 may display, in some non-limiting examples, a casino wagering game, segments of a wagering game, information associated with wagering games, community games, progressive games, non-wagering games, advertisements, services, premium entertainment, text messaging, emails, alerts or announcements, broadcast information, subscription information, etc. According to the illustrated example of FIG. 4, the first electronic display device 112 includes a first video display panel 118 with a first glass panel 120 overlaying or otherwise covering the first video display panel 118. Likewise, the second electronic display device 114 includes a second glass panel 124 overlaying or otherwise covering a second video display panel 122, whereas the third electronic display device 116 includes a third glass panel 128 overlaying or otherwise covering a third video display panel 126. The display panels 118, 122, 126 can be attached to their respective glass panels 120, 124, 128, for example, via a corresponding bezel and insulation assembly (not visible in the views provided). Each video display panel 118, 122, 126 is configured to dynamically display aspects of a wagering game (e.g., moving and static text, graphics, images, etc.).

With continuing reference to FIG. 4, the three display devices 112, 114, 116 are shown mounted side-by-side, in a non-coplanar relationship with one another. In particular, the first electronic display device 112 is mounted at a first location in a first generally vertical orientation, e.g., with respect to a cabinet of a floor-standing gaming terminal. The second electronic display device 114, on the other hand, is mounted at a second location in a second generally vertical orientation, while the third electronic display device 116 is mounted at a third location in a third generally vertical orientation, e.g., with respect to the cabinet of the gaming terminal. The first, second and third locations are distinct from one another, while the first, second and third orientations are distinct from one another, according to the illustrated example. Electronic display devices 112, 114, 116 are mounted such that a left side (e.g., the left edge) of the first display device 112 is adjacent and generally parallel to a right side (e.g., the right edge) of the second display device 114, while a right side (e.g., the right edge) of the first display device 112 is adjacent and generally parallel to a left side (e.g., the left edge) of the third display device 116. The second electronic display device 114 is shown mounted at a first oblique angle A1 to the first electronic display device 112, and the third display device 116 is shown mounted at a second oblique angle A2 to the first electronic display device 112. By way of non-limiting example, the first and second oblique angles A1, A2 are approximately 125-165 degrees or, in some embodiments, approximately 140-150 degrees or, in some embodiments, approximately 145 degrees. It may be desirable, for some configurations, that the oblique angles A1, A2 be distinct from one another.

In the illustrated embodiment, the electronic display devices 112, 114, 116 are spaced horizontally from one another such that the multi-display arrangement 100—the combined three display devices—provides a portrait view of a wagering game environment. However, the relative orientation of the multi-display arrangement 100 with respect to the terminal's cabinet is not limited to that which is illustrated. For instance, the three electronic display devices 112, 114, 116 may be horizontally spaced, vertically spaced, diagonally spaced, or a combination thereof, without departing from the intended scope and spirit of this disclosure. To this regard, the electronic display devices 112, 114, 116 are each mounted in a generally vertical orientation in the embodiment shown; nevertheless, it is also within the scope of this disclosure for the display devices 112, 114, 116 to take on non-vertical orientations, such as slant top and table top orientations. Other characteristics, such as the relative angle of orientation, the distance of separation, the respective locations on the cabinet, etc., can be varied from that which is shown in the drawings.

Disposed between neighboring display devices of the multi-display arrangement is an elongated transition spacer that provides a visually seamless transition between adjacent display glass panels. By way of example, and not limitation, a first transition spacer 130 is interposed between the first and second glass panels 120, 124 of the first and second display devices 112, 114, while a second transition spacer 132 is interposed between the first and third glass panels 120, 128 of the first and third display devices 112, 116. The transition spacers 130, 132 are shown extending the entire length or substantially the entire length of the edges of the glass panels 120, 124, 128. In the same vein, the transition spacers 130, 132 are shown extending the entire distance between the glass panels 120, 124, 126. The first and second transition spacers 130, 132 of FIG. 4 are substantially structurally identical; thus, for brevity and conciseness, additional features of both spacers 130, 132 will be described with respect to the first transition spacer 130 portrayed in FIGS. 5-7.

Shown in FIG. 5 seated at least partially inside and extending across a gap 104 between the first and second glass panels 120, 124 of the first and second display devices 112, 114 is a first transition spacer 130. Extending longitudinally along the length of the transition spacer 130 on opposing sides thereof is a pair of elongated channels or pockets 134, 136. Each pocket 134, 136 seats therein one of the edges of a respective one of the glass panels 120, 124. Specifically, the left edge (or left-hand side) of the first glass panel 120 nests inside the first pocket 134, while the right edge (or right-hand side) of the second glass panel 124 nests inside the second pocket 136. These pockets 134, 136 couple to the edges of the glass panels 120, 124, e.g., via interference fit (also known as a “friction fit”). Optional configurations can employ mechanical fasteners and/or adhesives to attach the transition spacer 130 to the glass panels 120, 124. To ensure a more flush fit and thereby improve attachment between the spacer and glass panels, the edges of the first and second glass panels 120, 124 have beveled or rounded corners which complement the internal periphery of the pockets 134, 136. By seating the edges of the first and second glass panels 120, 124 inside the first and second pockets 134, 136, the transition spacer 130 aligns the first glass panel 120 with respect to the second glass panel 124 and helps to maintain the desired orientation and angle of the glass panels. Moreover, the transition spacer 130 at least partially seals the gap 104 between the first and second glass panels 120, 124 to thereby reduce the ingress of moisture into the display arrangement 100 proximate the first and second electronic display devices 112, 114.

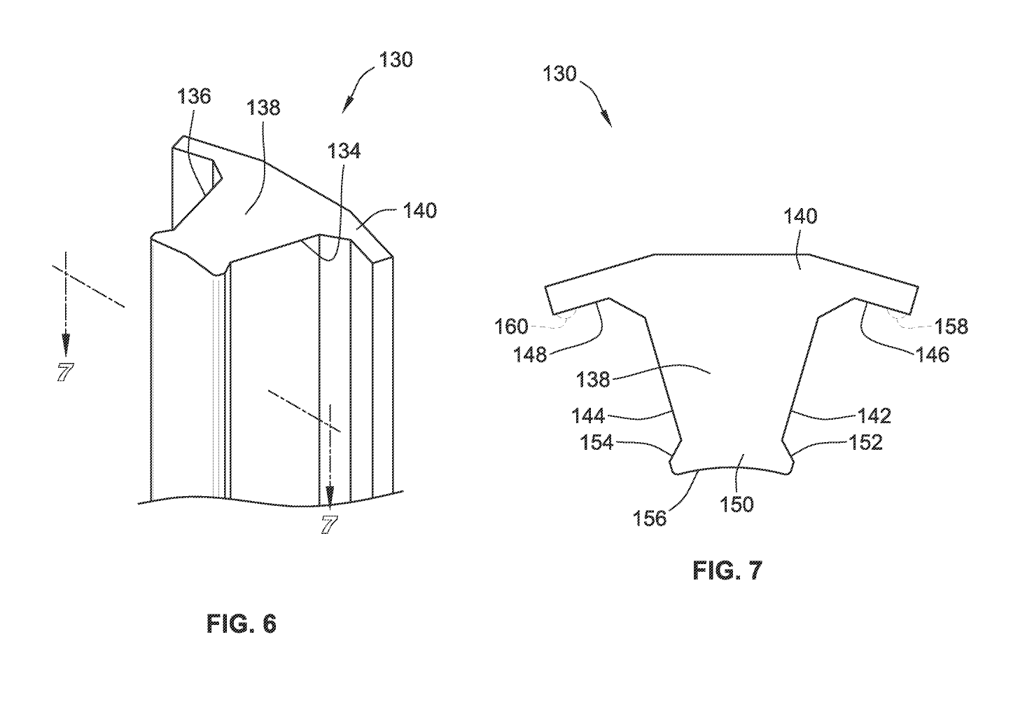

Turning to FIGS. 6 and 7, the elongated transition spacer 130 has a T-shaped cross section with an elongated stem 138 and an elongated crossbar 140 (also known as “bar” or “arm” in typography anatomy) that extends transversely across a first (top) end of the stem 138. In accordance with the illustrated example, the thickness of the stem 138 of the transition spacer 130 varies along the length of the stem 138. As seen in FIG. 7, for example, the first (top) end of the stem 138 has a first thickness, whereas a second (bottom) end of the stem 138 has a second thickness which is less than the first thickness. The varying thickness of the stem 138 provides complementary ramped surfaces 142 and 144 against which the lateral edges of the glass panels 120, 124 can press to ensure a better seal and a more secure attachment between the spacer 130 and panels 120, 124. In the same vein, the crossbar 140 of the transition spacer 130 is curvilinear to provide complementary surfaces 146 and 148 against which portions of the rear surfaces of the glass panels 120, 124 can rest. The transition spacer 130 also includes a first (stem) serif 150 at the second end thereof to provide complementary surfaces 152 and 154 against which can rest portions of the front surfaces of the glass panels 120, 124. In addition, the first serif 150 at the second end of the stem 138 has a concave outer surface to provide a smooth transition surface between the neighboring glass panels 120, 124. As another option, the opposing ends of the crossbar 140 can include second and third serifs, shown hidden at 158 and 160 respectively, to provide a better interference fit between the transition spacer 130 and the glass panels 120, 124. Potential materials for the transition spacer include thermoplastics, such as thermoplastic elastomers, and other flexible polymers, or metallic materials, such as aluminum.

The present invention is not limited to the precise construction and compositions disclosed herein; any and all modifications, changes, and variations apparent from the foregoing descriptions are within the spirit and scope of the invention as defined in the appended claims. Moreover, the present concepts expressly include any and all combinations and subcombinations of the preceding elements and aspects.

What is claimed:

1. An electronic gaming machine primarily dedicated to conducting at least one regulated casino wagering game, the electronic gaming machine comprising:
a gaming cabinet;
first and second electronic display devices coupled to the gaming cabinet in side-by-side non-coplanar relationship, the first electronic display device including a first video display panel and a first glass panel overlaying the first video display panel, the second electronic display device including a second video display panel and a second glass panel overlaying the second video display panel, the first and second video display panels each being configured to display aspects of the casino wagering game; and
an elongated transition spacer seated at least partially inside and extending across a gap between the first and second glass panels, the transition spacer defining first and second pockets on opposing sides thereof, wherein the first and second pockets each seats therein an edge of a respective one of the first and second glass panels.

2. The gaming machine of claim 1, wherein the transition spacer has a T-shaped cross section with an elongated stem and an elongated crossbar extending transversely at a first end of the stem.

3. The gaming machine of claim 2, wherein the transition spacer includes a first serif at a second end of the stem.

4. The gaming machine of claim 3, wherein the first serif at the second end of the stem has a concave outer surface.

5. The gaming machine of claim 2, wherein the transition spacer includes second and third serifs at opposing ends of the crossbar.

6. The gaming machine of claim 2, wherein a thickness of the stem of the transition spacer varies along the length of the stem.

7. The gaming machine of claim 2, wherein the crossbar is curvilinear.

8. The gaming machine of claim 1, wherein the edges of the first and second glass panels have beveled or rounded corners.

9. The gaming machine of claim 1, wherein the first glass panel is oriented at an oblique angle with respect to the second glass panel.

10. The gaming machine of claim 1, wherein the first and second electronic display devices are mounted in a horizontal orientation on the cabinet.

11. The gaming machine of claim 1, wherein the transition spacer at least partially seals the gap between the first and second glass panels to thereby reduce ingress of moisture into the first and second electronic display devices.

12. The gaming machine of claim 1, wherein seating the edges of the first and second glass panels inside the respective first and second pockets aligns the first glass panel with respect to the second glass panel.

13. The gaming machine of claim 1, wherein the first and second pockets friction fit to the edges of the respective first and second glass panels.

14. The gaming machine of claim 1, further comprising:
a third electronic display device coupled to the gaming cabinet in side-by-side non-coplanar relationship with the first electronic display device, the third display device including a third video display panel and a third glass panel overlaying the third video display panel, the third video display panel being configured to display aspects of the casino wagering game; and
a second elongated transition spacer seated at least partially inside and extending across a second gap between the first and third glass panels, the second transition spacer defining pockets on opposing sides thereof, wherein the pockets each seats therein and attaches to a lateral edge of a respective one of the first and third glass panels.

15. A gaming system primarily dedicated to conducting a wagering game, the gaming system comprising:
a gaming cabinet configured to house electronic components;
an electronic input device mounted on the cabinet and configured to receive a physical input from a player to initiate the wagering game and transform the physical input into an electronic data signal;
game-logic circuitry including a random element generator configured to generate one or more random elements associated with play of the wagering game in response to the electronic data signal from the electronic input device;
first and second electronic display devices mounted on the cabinet in side-by-side non-coplanar relationship, the first electronic display device including a first video display panel covered with a first glass panel, the second electronic display device including a second video display panel covered with a second glass panel, the first and second video display panels each being configured to display aspects of the wagering game; and
an elongated transition spacer seated at least partially inside and extending across a gap between the first and second glass panels, the transition spacer defining first and second pockets on opposing sides thereof, wherein the first and second pockets each seats therein and couples to an edge of a respective one of the first and second glass panels.

16. The gaming system of claim 15, wherein the transition spacer has a T-shaped cross section with an elongated stem and an elongated crossbar extending transversely at a first end of the stem.

17. The gaming system of claim 16, wherein the transition spacer includes a first serif at a second end of the stem, the first serif having a concave outer surface.

18. The gaming system of claim 15, wherein a thickness of the stem of the transition spacer varies along the length of the stem.

19. The gaming system of claim 15, wherein the first video display panel and first glass panel are oriented at an oblique angle with respect to the second video display panel and second glass panel.

20. A multi-display arrangement for an electronic gaming machine with a cabinet, the multi-display arrangement comprising:
a first electronic display device configured to mount to the cabinet in a first position, the first electronic display device having a first video display panel and a first glass panel overlaying the first video display panel, the first video display panel being configured to dynamically display aspects of a casino wagering game;
a second electronic display device configured to mount to the cabinet in a second position adjacent to and at an oblique angle with the first electronic display device, the second electronic display device having a second video display panel and a second glass panel overlaying the second video display panel, the second video display panel being configured to dynamically display aspects of the casino wagering game; and
an elongated transition spacer seated substantially inside and extending across a gap between the first and second glass panels, the transition spacer defining first and second pockets on opposing sides thereof, wherein the first and second pockets each seats therein an edge of a respective one of the first and second glass panels.
